(19) United States
(12) Patent Application Publication
(10) Pub. No.: US 2026/0117951 A1
(43) Pub. Date: Apr. 30, 2026

(54) LUMINOUS EMBLEM

(71) Applicant: TOYODA GOSEI CO., LTD., Kiyosu-shi (JP)

(72) Inventors: Yoshihide NODA, Aichi (JP); Hirotaka FUKUI, Aichi (JP); Keigo KONDO, Aichi (JP)

(21) Appl. No.: 19/368,949

(22) Filed: Oct. 24, 2025

(30) Foreign Application Priority Data
Oct. 29, 2024 (JP) 2024-189773
Apr. 22, 2025 (JP) 2025-070352

(51) Int. Cl. F21S 43/00; B60R 13/00; F21S 43/14; F21S 43/20; F21S 43/247; F21S 43/50; F21Y 115/10

(52) U.S. Cl. CPC F21S 43/601; B60R 13/005; F21S 43/247; F21S 43/265; F21S 43/50; F21S 43/14; F21Y 2115/10

(57) ABSTRACT

A luminous emblem has an outer lens configuring a design of the luminous emblem, a housing, a light-emitting element accommodated in a space sealed by the housing and the outer lens and configured to emit light toward the outer lens, and a light adjustment layer provided between the light-emitting element and the outer lens. The light adjustment layer includes a light transmissive portion configured to transmit light emitted from the light-emitting element, and a light adjustment portion configured to adjust a brightness or a color of the light emitted from the light-emitting element.

### CROSS-REFERENCE TO RELATED APPLICATIONS

This application is based on and claims priority under 35 USC 119 from Japanese Patent Applications No. 2024-189773 filed on Oct. 29, 2024 and No. 2025-070352 filed on Apr. 22, 2025, the entire content of which is incorporated herein by reference.

### TECHNICAL FIELD

The present disclosure relates to a luminous emblem, particularly to a luminous emblem installed in a vehicle such as an automobile.

### BACKGROUND ART

In the prior art, a luminous emblem shining with a design of the emblem is known. For example, JP2024-004826A discloses a luminous emblem in which light emission is made uniform by individually controlling light emission states of a plurality of LEDs used as a light source.

In recent years, the thickness of the luminous emblem has been reduced, and there might be no space where the light source is hidden due to restrictions on the design of the emblem. In such a case, when the luminous emblem is thinned, the distance from the light source to an outer lens having the design of the emblem becomes very short. As a result, even when an inner lens serving as a light guide is provided between the light source and the outer lens, it is in a state that light is concentrated directly above the light source. As a result, the degree of brightness differs depending on the position, and unevenness of the light color occurs. It is required to improve it from the point of view. In addition, in a case where each light emission state of the LEDs is individually controlled as in JP2024-004826A, power cost increases.

### SUMMARY OF INVENTION

An object of the present disclosure is to provide a luminous emblem that suppresses concentration of light directly above a light source and achieves uniform light emission while reducing power cost.

(Aspect 1) A luminous emblem having:
an outer lens constituting a design of the luminous emblem;
a housing;
a light-emitting element that is accommodated in a space sealed by the housing and the outer lens and that is configured to emit light toward the outer lens; and
a light adjustment layer that is provided between the light-emitting element and the outer lens, in which
the light adjustment layer includes a light transmissive portion that is configured to transmit the light emitted from the light-emitting element, and a light adjustment portion that is configured to adjust a brightness or a color of the light emitted from the light-emitting element.

(Aspect 2) The luminous emblem according to Aspect 1, in which
the light adjustment layer is made of a light adjustment film having a film body with a printed pattern for adjusting the brightness or the color of the light emitted from the light-emitting element, the film body transmitting the light emitted from the light-emitting element.

(Aspect 3) The luminous emblem according to Aspect 2, in which
the film body of the light adjustment film includes an exposed portion with no printed pattern and a printed portion with the printed pattern,
the exposed portion constitutes the light transmissive portion,
the printed portion constitutes the light adjustment portion, and
the exposed portion and the printed portion forms a predetermined repetitive pattern.

(Aspect 4) The luminous emblem according to Aspect 3, in which
the predetermined repetitive pattern is a dot pattern.

(Aspect 5) The luminous emblem according to Aspect 3, in which
the light adjustment film is configured such that a ratio of the exposed portion increases and a ratio of the printed portion decreases as the light-emitting element increases in distance from the light adjustment film.

(Aspect 6) The luminous emblem according to Aspect 3, in which
the printed portion is configured to block the light emitted from the light-emitting element.

(Aspect 7) The luminous emblem according to Aspect 2, in which
the film body is configured to diffuse the light emitted from the light-emitting element.

(Aspect 8) The luminous emblem according to Aspect 1, in which
the outer lens has the space provided inside the outer lens, and
the housing is provided to close an opening of the outer lens and seal the space.

(Aspect 9) The luminous emblem according to Aspect 1, further including:
an inner lens that is provided between the light-emitting element and the outer lens and that is configured to guide the light emitted from the light-emitting element in a direction intersecting an optical axis of the light-emitting element, in which
the light adjustment layer is provided between the inner lens and the outer lens.

(Aspect 10) The luminous emblem according to Aspect 1, in which
the light adjustment layer has a decorative layer that is configured to form a pattern for adjusting the brightness or the color of the light emitted from the light-emitting element on an inner wall of the outer lens,
a portion where the pattern of the decorative layer is not formed constitutes the light transmissive portion, and
a portion where the pattern is formed constitutes the light adjustment portion.

(Aspect 11) The luminous emblem according to Aspect 10, in which
the light adjustment layer includes a protective layer that is provided to cover and protect the decorative layer.

According to the luminous emblem configured as described above, it is possible to provide the luminous emblem in which concentration of light directly above a light source is suppressed and light emission is uniformized while reducing power cost.

### BRIEF DESCRIPTION OF DRAWINGS

Exemplary embodiment(s) of the present invention will be described in detail based on the following figures, wherein:

FIG. 1 is a plan view of a luminous emblem according to an embodiment of the present disclosure;

FIG. 2A is a cross-sectional view showing an example of a vertical cross section of the luminous emblem taken along line A-A shown in FIG. 1;

FIGS. 2B and 2C are plan views illustrating examples of a light adjustment film;

FIGS. 3A to 3C are plan views showing modifications of the light adjustment film;

FIG. 4 is a vertical sectional view of a luminous emblem according to a modification of the present disclosure;

FIG. 5 is a vertical sectional view of a luminous emblem according to another embodiment of the present disclosure;

FIGS. 6A and 6B are vertical sectional views of luminous emblems according to other embodiments of the present disclosure; and

FIG. 7 is an exploded view of a luminous emblem according to another embodiment of the present disclosure.

### DESCRIPTION OF EMBODIMENTS

### (Configuration of Luminous Emblem)

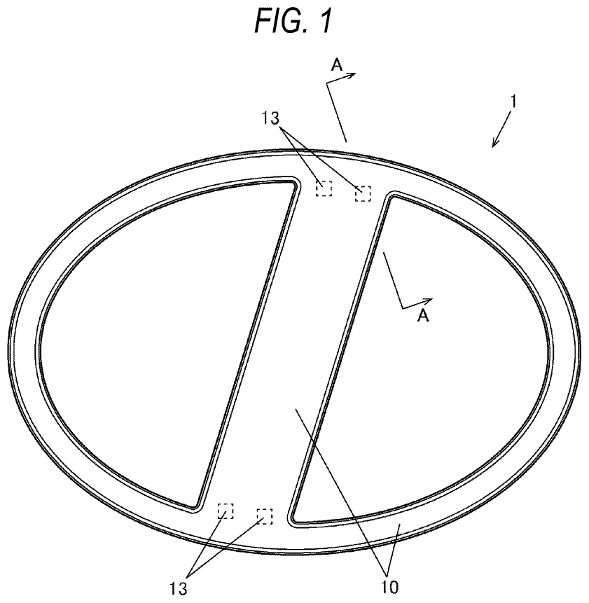

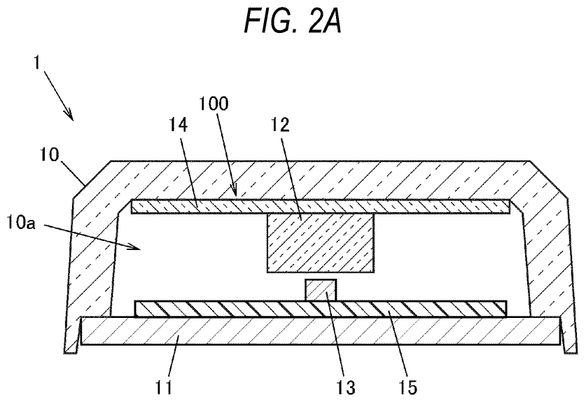

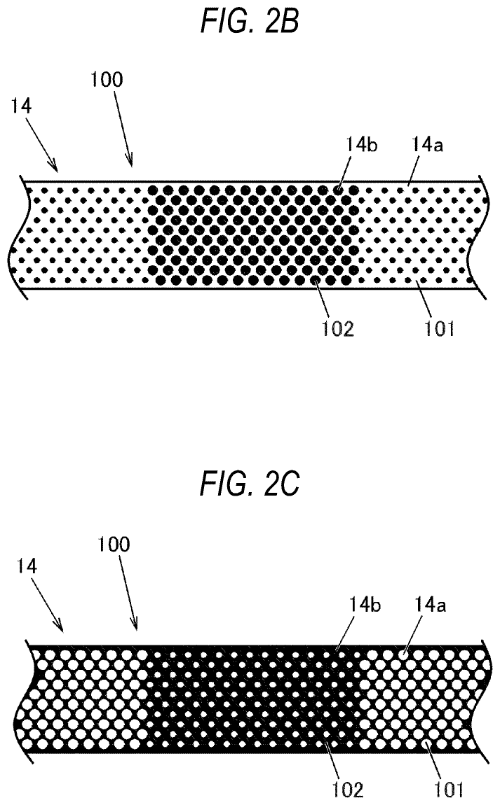

FIG. 1 is a plan view of a luminous emblem 1 according to an embodiment of the present disclosure. FIG. 2A is a cross-sectional view showing an example of a vertical cross section of the luminous emblem 1 cut along a line A-A shown in FIG. 1.

The luminous emblem 1 includes an outer lens 10 configuring a design of the luminous emblem 1, a housing 11, a light-emitting element 13 as a light source, an inner lens 12, and a light adjustment film 14. In the luminous emblem 1, light emitted from the light-emitting element 13 is extracted from the surface of the outer lens 10, and thus the design of the emblem shines.

The outer lens 10 is made of, for example, a resin such as PMMA (methyl methacrylate) or PC that transmits light emitted from the light-emitting element 13. The outer lens 10 may contain a diffusing material such as TiO2 particles in order to improve the uniformity of light extracted from the surface thereof. The outer lens 10 may be transparent or milky white. In the example illustrated in FIG. 1, the design of the emblem is a mark formed by a combination of an elliptical frame and an I shape. The design of the emblem is not limited to the illustrated design and can be changed as appropriate.

The outer lens 10 has a concave space 10a provided inside the outer lens 10, and is configured to accommodate the light-emitting element 13, the inner lens 12, and the light adjustment film 14 in the space 10a. The space 10a is formed so as to open toward the installation surface side of the luminous emblem 1 (lower side in FIG. 2A).

The housing 11 is formed in a plate shape, and is provided to close the opening of the space 10a of the outer lens 10 and seal the space 10a. The housing 11 is made of, for example, acrylonitrile-styrene-acrylic acid ester (ASA), acrylonitrile-butadiene-styrene (ABS)+polycarbonate (PC), or acrylonitrile-ethylene-propylene-diene-styrene (AES).

The light-emitting element 13 is accommodated in a space 10a sealed by the housing 11 and the outer lens 10. Typically, an LED is used as the light-emitting element 13. The light-emitting element 13 is mounted on a printed circuit board 15, and the printed circuit board 15 is fixed to the surface of the housing 11 (the surface facing the space 10a) such that the surface on which the light-emitting element 13 is mounted faces the outer lens 10. An optical axis of the light-emitting element 13 is in a direction of the normal to a surface of the housing 11 (or a ground surface of the luminous emblem 1), and the light-emitting element 13 emits light toward the outer lens 10.

The inner lens 12 is provided between the light-emitting element 13 and the outer lens 10, and guides the light emitted from the light-emitting element 13 in a direction intersecting the optical axis of the light-emitting element 13 (here, a direction mainly perpendicular to the optical axis). The inner lens 12 is made of, for example, a resin such as PMMA or PC that transmits the light emitted from the light-emitting element 13. since the inner lens 12 is provided, the light emitted from the light-emitting element 13 can be guided to the outer lens 10 at a position away from the light-emitting element 13, and light emission of the luminous emblem 1 can be made uniform. However, not all of the light emitted from the light-emitting element 13 is guided by the inner lens 12, and a part of the light emitted from the light-emitting element 13 passes through the inner lens 12 and enters the outer lens 10 directly above the light-emitting element 13. In particular, in the luminous emblem 1 in which the distance between the light-emitting element 13 and the outer lens 10 is short due to the reduction in thickness, the brightness immediately above the light-emitting element 13 becomes too strong, which may cause so-called point light or unevenness in light color.

Therefore, in the present embodiment, a light adjustment layer 100 for adjusting a brightness or a light color is provided between the inner lens 12 and the outer lens 10. The light adjustment layer 100 is provided to cover at least directly above the light-emitting element 13 (at a position intersecting the optical axis of the light-emitting element 13). In the present embodiment, the light adjustment layer 100 is made of a light adjustment film 14 attached to the back surface of the outer lens 10 (inner peripheral surface of the space 10a). For example, an adhesive or a double-sided tape can be used to attach the light adjustment film 14. The inner lens 12 is not essential and can be omitted. In this case, the light may be guided by a member different from the inner lens 12.

FIG. 2B is a plan view illustrating an example of the light adjustment film 14 constituting the light adjustment layer 100. The light adjustment layer 100 includes a light transmissive portion 101 that transmits the light emitted from the light-emitting element 13, and a light adjustment portion 102 configured to adjust a brightness or a color of the light. The light adjustment film 14 used as the light adjustment layer 100 in the present embodiment is configured by printing a pattern (hereinafter, referred to as a printed pattern) for adjusting the brightness or the color of the light on a film body that transmits the light emitted from the light-emitting element 13. Hereinafter, a portion where the printing is not performed and the film body is exposed is referred to as an exposed portion 14a, and a portion where the printing is performed is referred to as a printed portion 14b. When the light adjustment film 14 is used as the light adjustment layer 100, the exposed portions 14a constitute the light transmissive portion 101, and the printed portions 14b constitute the light adjustment portion 102.

By appropriately changing the printed pattern of the light adjustment film 14 provided directly above the light-emitting element 13, the brightness and color development of light transmitted through the light adjustment film 14 can be appropriately adjusted. Therefore, it is possible to suppress light from being concentrated directly above the light-emitting element 13 which is the light source, and it is possible to achieve uniform light emission and uniform light color.

Here, the exposed portions 14a (that is, the film body) is transparent with respect to the light emitted from the light-emitting element 13 (that is, visible light). However, it is not limited thereto, and for example, the exposed portions 14a (that is, the film body) may be configured to have a milky white color including a diffusion material to diffuse the light emitted from the light-emitting element 13.

Further, in the present embodiment, the printed portions 14b are black to block the light emitted from the light-emitting element 13. The printed portions 14b shield a part of the light emitted from the light-emitting element 13 to suppress the brightness of a portion where the light is concentrated, thereby uniformizing the light emission of the luminous emblem 1. However, it is not limited thereto, and the printed portions 14b may partially transmit the light emitted from the light-emitting element 13, or may be colored in a predetermined color for adjusting the light color. As a result, unevenness in the light color can be suppressed, and the light emission of the luminous emblem 1 can be made more uniform. In order to adjust the brightness (that is, uniformize the light emission), the transmittance of the light emitted from the light-emitting element 13 in the printed portions 14b may be lower than that of the exposed portions 14a.

In the light adjustment film 14, the printing may be performed such that either the exposed portions 14a or the printed portions 14b form a predetermined repetitive pattern. In the present embodiment, as illustrated in FIG. 2B, the light adjustment film 14 is formed such that the printed portions 14b form a repetitive pattern of a dot pattern. Although FIG. 2B shows a case where the circular printed portions 14b forming the dot pattern are arranged in a staggered manner, but for example, it might be a printed pattern in which the circular printed portions 14b are arranged not in a staggered manner but vertically and horizontally at equal intervals. By adjusting a ratio of the area of the exposed portions 14a to the area of the printed portions 14b in the light adjustment film 14, the brightness and the light color can be appropriately adjusted. It can be said that it is desirable to make the size of the printed portions 14b (the size of the dot) as small as possible in order to suppress unevenness in brightness and color development. The distance between the printed portions 14b (that is, the distance between the dots) may be appropriately adjusted so as to have appropriate brightness and light color in consideration of the size of the printed portions 14b, the brightness of light incident from the light-emitting element 13, and the like.

Here, the light emitted from the light-emitting element 13 is strongest immediately above the light-emitting element 13, and becomes weaker as the distance from the light-emitting element 13 increases. Therefore, in order to make the light emission of the luminous emblem 1 uniform, the printed pattern of the light adjustment film 14 may be set such that the ratio of the exposed portions 14a increases and the ratio of the printed portions 14b decreases as the distance from the light-emitting element 13 increases. In the example of FIG. 2B, the ratio between the exposed portions 14a and the printed portions 14b is adjusted by changing the size of the printed portions 14b while the arrangement of the dots of the printed portions 14b is constant. However, it is not limited thereto, and for example, the ratio between the exposed portions 14a and the printed portions 14b may be adjusted by changing the number (that is, density) of the printed portions 14b while keeping the size of the printed portions 14b constant. The variation in the ratio between the exposed portions 14a and the printed portions 14b may gradually change according to the distance from the light-emitting element 13, or may change stepwise.

FIG. 2B shows the case where the light adjustment film 14 is made such that the printed portions 14b form the dot pattern, but as illustrated in FIG. 2C, the light adjustment film 14 may be made such that the exposed portions 14a and the printed portions 14b are reversed and the exposed portions 14a form the dot pattern.

### (Modifications)

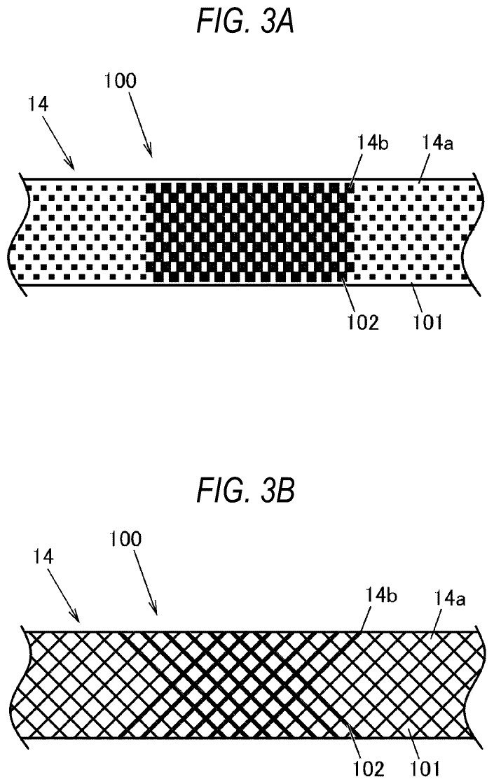

In the present embodiment, the case where the printed pattern of the light adjustment film 14 is a dot pattern has been described, but it is not limited thereto. For example, as shown in FIG. 3A, the shape of the printed portion 14b may be a rectangular shape. Although not illustrated, the shape of the printed portion 14b may be a triangular shape, an elliptical shape, a rhombus shape, a polygonal shape, or the like. Further, for example, as illustrated in FIG. 3B, the printed portions 14b may have a lattice shape. In FIGS. 3A and 3B, the exposed portions 14a and the printed portions 14b may be reversed.

In addition, as shown in FIG. 3C, the pattern of the light adjustment film 14 may be formed such that the ratio of the exposed portions 14a with respect to the printed portions 14b gradually increases (that is, the ratio of the light transmissive portion 101 with respect to the light adjustment portion 102 gradually increases) in a concentric manner as the distance from the light-emitting element 13 increases. In FIG. 3C, regions are partitioned concentrically around a position facing the light-emitting element 13, and a pattern is formed such that dots constituting the exposed portions 14a become larger in a region farther from the light-emitting element 13.

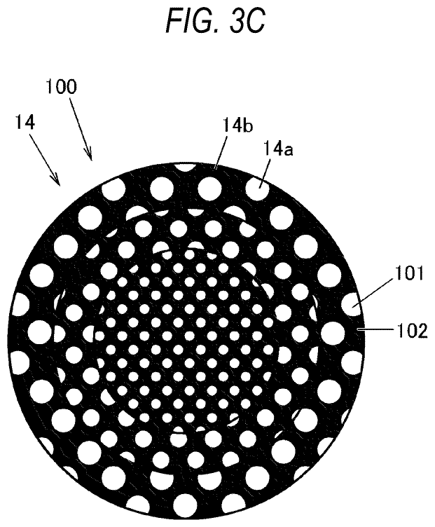

In the present embodiment, since the side surface of the luminous emblem 1 is formed by the outer lens 10, the light emitted from the light-emitting element 13 may be concentrated on the side surface. In such a case, as shown in FIG. 4, by providing the light adjustment film 14 on the inner wall on the side surface side of the outer lens 10, it is possible to make the light emission more uniform and to suppress the point light and the like due to the side surface light emission of the light-emitting element 13. In this case, the light adjustment film 14 may be shaped in advance into a shape corresponding to the inner surface of the outer lens 10, and the shaped light adjustment film 14 may be attached to the inner surface of the outer lens 10.

### Effects of Embodiment

According to the luminous emblem 1 of the present embodiment described above, even when the distance between the outer lens 10 and the light-emitting element 13 is short due to the reduction in thickness, it is possible to suppress concentration of light immediately above the light-emitting element 13 and to make light emission uniform. Further, in the luminous emblem 1, since it is not necessary to individually control the light-emitting elements 13, it is possible to reduce power cost.

### Other Embodiments

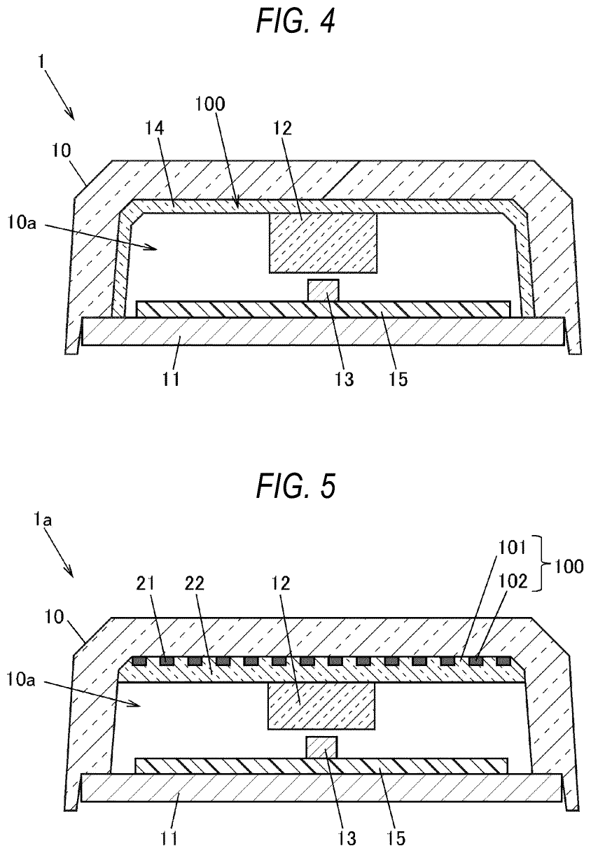

FIG. 5 is a vertical cross-sectional view of a luminous emblem 1a according to another embodiment of the present disclosure. The luminous emblem 1a shown in FIG. 5 has basically the same configuration as the luminous emblem 1 shown in FIG. 2A, and only the configuration of the light adjustment layer 100 is different.

In the luminous emblem 1a, the light adjustment layer 100 includes a decorative layer 21 in which a pattern for adjusting the brightness or the color of light is formed on the inner wall of the outer lens 10. A portion where the pattern of the decorative layer 21 is not formed constitutes the light transmissive portion 101, and a portion where the pattern is formed constitutes the light adjustment portion 102.

The decorative layer 21 is a layer corresponding to the printed portions 14b of the light adjustment film 14. The decorative layer 21 is formed by, for example, coating or sputtering the inner wall of the outer lens 10 to form a film, and then removing a part of the film with a laser to form the pattern of the decorative layer 21. The method of forming the decorative layer 21 is not limited thereto, and the decorative layer 21 may be formed by, for example, inkjet-printing. Here, the decorative layer 21 is formed in a black pattern to block the light emitted from the light-emitting element 13, but the decorative layer 21 may partially transmit the light emitted from the light-emitting element 13 or may be colored in a predetermined color for adjusting the light color. The pattern of the decorative layer 21 may be the same as that of the printed portions 14b of the light adjustment film 14.

The light adjustment layer 100 further includes a protective layer 22 that is provided to cover the decorative layer 21 and protects the decorative layer 21. The protective layer 22 is a layer corresponding to the exposed portions 14a of the light adjustment film 14. The protective layer 22 is transparent with respect to the light emitted from the light-emitting element 13 (that is, visible light), but the light color may be adjusted by, for example, making the protective layer 22 milky white or coloring the protective layer 22 in a predetermined color. The protective layer 22 enters a portion where the film is removed in the decorative layer 21, and also plays a role of filling the unevenness of the decorative layer 21. In other words, the decorative layer 21 is embedded in the protective layer 22.

Since the decorative layer 21 and the protective layer 22 constitute the light adjustment layer 100, defects such as positional deviation of the light adjustment layer 100 with respect to the outer lens 10 are less likely to occur. Although FIG. 5 shows the case where the light adjustment layer 100 is formed only on the upper inner wall of the outer lens 10, the light adjustment layer 100 may also be formed on the inner wall on the side surface side of the outer lens 10.

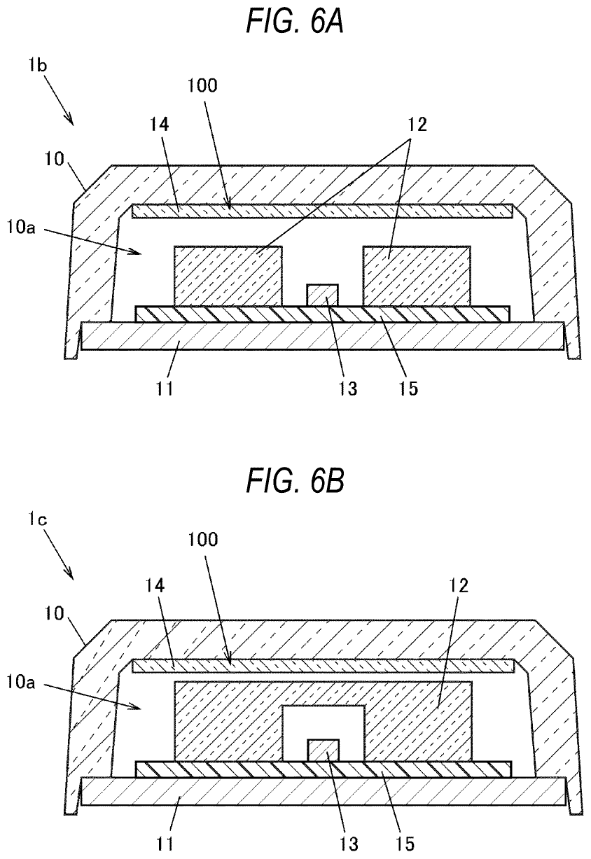

The luminous emblems 1b and 1c shown in FIGS. 6A and 6B have basically the same configuration as the luminous emblem 1 shown in FIG. 2A, and only the configuration of the inner lens 12 is different. In the luminous emblem 1b, the inner lenses 12 are provided to cover the lateral side of the light-emitting element 13. Accordingly, light emitted from the side surface of the light-emitting element 13 can be guided by the inner lenses 12, and point light or the like due to side surface light emission can be suppressed. In the luminous emblem 1c, the inner lens 12 is provided to cover the upper side and the lateral side of the light-emitting element 13. Accordingly, it is possible to suppress point light on both sides and above. The portion of the inner lens 12 directly above the light-emitting element 13 may form a total internal reflection (TIR) lens 12a that reflects light traveling upward laterally or obliquely. As a result, light emitted from the light-emitting element 13 directly above can be condensed by the TIR lens 12a and scattered in a lateral direction or an oblique direction, and point light can be further suppressed.

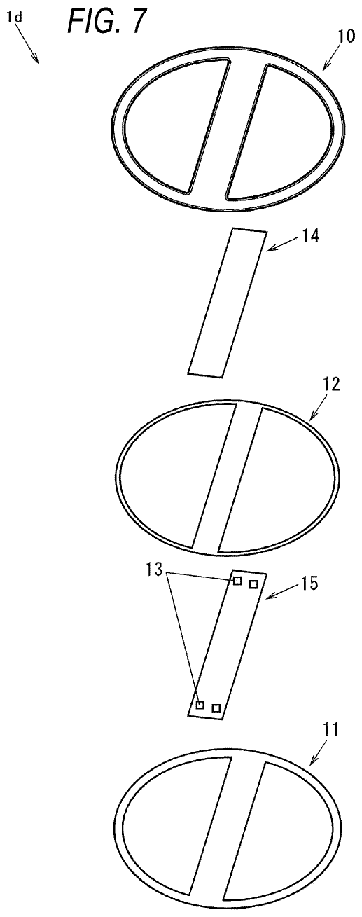

As like a luminous emblem 1d shown in FIG. 7, the inner lens 12 is preferably formed from one component. Thus, the luminous emblem 1d can be easily assembled.

Although the embodiments of the present disclosure has been described above, the present invention is not limited to the above-described embodiment, and various modifications can be made without departing from the gist of the invention. In addition, the components of the above-described embodiments can be arbitrarily combined without departing from the gist of the invention. In addition, the invention according to claims is not to be limited to the above-described embodiments. Further, please note that all combinations of the features described in the embodiments are not necessary to solve the problem of the invention.

What is claimed is:

1. A luminous emblem comprising:
an outer lens configuring a design of the luminous emblem;
a housing;
a light-emitting element that is accommodated in a space sealed by the housing and the outer lens and that is configured to emit light toward the outer lens; and
a light adjustment layer that is provided between the light-emitting element and the outer lens, wherein
the light adjustment layer includes a light transmissive portion that is configured to transmit the light emitted from the light-emitting element, and a light adjustment portion that is configured to adjust a brightness or a color of the light emitted from the light-emitting element.

2. The luminous emblem according to claim 1, wherein
the light adjustment layer is made of a light adjustment film having a film body with a printed pattern for adjusting the brightness or the color of the light emitted from the light-emitting element, the film body transmitting the light emitted from the light-emitting element.

3. The luminous emblem according to claim 2, wherein
the film body of the light adjustment film includes an exposed portion with no printed pattern and a printed portion with the printed pattern,
the exposed portion constitutes the light transmissive portion,
the printed portion constitutes the light adjustment portion, and
the exposed portion and the printed portion form a predetermined repetitive pattern.

4. The luminous emblem according to claim 3, wherein
the predetermined repetitive pattern is a dot pattern.

5. The luminous emblem according to claim 3, wherein
the light adjustment film is configured such that a ratio of the exposed portion increases and a ratio of the printed portion decreases as the light-emitting element increases in distance from the light adjustment film.

6. The luminous emblem according to claim 3, wherein
the printed portion is configured to block the light emitted from the light-emitting element.

7. The luminous emblem according to claim 2, wherein
the film body is configured to diffuse the light emitted from the light-emitting element.

8. The luminous emblem according to claim 1, wherein
the outer lens has the space provided inside the outer lens, and
the housing is provided to close an opening of the outer lens and seal the space.

9. The luminous emblem according to claim 1, further comprising:
an inner lens that is provided between the light-emitting element and the outer lens and that is configured to guide the light emitted from the light-emitting element in a direction intersecting an optical axis of the light-emitting element, wherein
the light adjustment layer is provided between the inner lens and the outer lens.

10. The luminous emblem according to claim 1, wherein
the light adjustment layer has a decorative layer that is configured to form a pattern for adjusting the brightness or the color of the light emitted from the light-emitting element on an inner wall of the outer lens,
a portion where the pattern of the decorative layer is not formed constitutes the light transmissive portion, and
a portion where the pattern is formed constitutes the light adjustment portion.

11. The luminous emblem according to claim 10, wherein
the light adjustment layer includes a protective layer that is provided to cover and protect the decorative layer.
